(19) United States
(12) Patent Application Publication
(10) Pub. No.: US 2014/0219313 A1
(43) Pub. Date: Aug. 7, 2014

(54) SYSTEM AND METHOD FOR CONDITION MONITORING OF MACHINERY

(71) Applicants: Paul Keith Schafer, Concord, NC (US); Dave McKeithan, Waxhaw, NC (US); Kenneth Patton, Waxhaw, NC (US); Dan Yin, Waxhaw, NC (US)

(72) Inventors: Paul Keith Schafer, Concord, NC (US); Dave McKeithan, Waxhaw, NC (US); Kenneth Patton, Waxhaw, NC (US); Dan Yin, Waxhaw, NC (US)

(73) Assignee: IMO INDUSTRIES, INC., Lawrenceville, NJ (US)

(21) Appl. No.: 14/123,465

(22) PCT Filed: Jun. 1, 2012
(86) PCT No.: PCT/US2012/040365

§ 371 Date: Apr. 10, 2014

Related U.S. Application Data
(60) Provisional application No. 61/493,027, filed on Jun. 3, 2011.

(51) Int. Cl. G01N 25/00; G01N 29/04

(52) U.S. Cl. CPC G01N 25/00; G01N 29/04
USPC 374/142

(57) ABSTRACT

A system and method for monitoring the operation condition of a wide variety of machinery is disclosed. A plurality of sensors, including temperature sensors and vibration sensors, are coupled to a controller. The controller receives input from the sensors and determines whether the temperature and vibration levels are within acceptable ranges with respect to baseline values. If the temperature and vibration levels fall outside the acceptable ranges, then respective visual indicators alert a user of such a condition. Multiple alarm levels are provided. A mounting arrangement is also provided in which a single threaded fastener can be used to attach the monitor to the machinery. The threaded fastener engages a through-wall metal recess in the monitor to efficiently conduct heat and vibration from the machinery to the temperature and vibration sensors within the monitor. The metal recess also serves to protect the monitor from damage during installation.

### CROSS-REFERENCE TO RELATED APPLICATIONS

This is a non-provisional of pending U.S. provisional patent application Ser. No. 61/493,027, filed Jun. 3, 2011, the entirety of which provisional application is incorporated by reference herein.

### FIELD OF THE DISCLOSURE

The disclosure is generally related to the field of monitoring systems for machinery, and more particularly to an improved system for continuous pump condition monitoring.

### BACKGROUND OF THE DISCLOSURE

The condition of rotating machinery is often determined using visual inspection techniques performed by experienced operators. Failure modes such as cracking, leaking, corrosion, etc. can often be detected by visual inspection before failure is likely. Temperature and vibration are key indicators of a pump's operating performance. Excessive levels of either one may indicate a need for adjustment and/or repair.

Temperature variations across a surface can be manually measured using, for example, thermographic techniques. In addition, headphones can be used to listen to for undesirable wear conditions. For example, high pitched buzzing sound in bearings may indicate flaws in the contact surfaces.

The use of such manual condition monitoring allows maintenance to be scheduled, or other actions to be taken, to avoid the consequences of failure before the failure occurs. Intervention in the early stages of deterioration is usually much more cost effective than undertaking repairs subsequent to failure.

One downside to manual monitoring is that it is typically only performed periodically. Thus, if an adverse condition arises between inspections, machinery failure can occur. It would, therefore, be desirable to automate condition monitoring processes to provide a simple, easy-to-use, system that provides constant monitoring of machinery conditions. Such a system has the potential to enhance operation, reduce downtime and increase energy efficiency. Such a system should be adapted for installation on new machinery during manufacture or added as a retrofit to existing equipment.

### SUMMARY OF THE DISCLOSURE

A system and method for machinery condition monitoring is disclosed. The monitor may include a plurality of sensors and a controller for receiving input from the plurality of sensors and determining at least one operating characteristic of the machinery from the input. The monitor may also include a mounting feature for attaching the plurality of condition sensors and the controller to the machinery. The mounting feature may be offset a first offset distance beyond a front surface of the monitor and may be offset a second offset distance beyond a rear surface of the monitor. The first offset distance may facilitate engagement between the mounting feature and a fastener used to couple the monitor to the machinery, while the second offset distance may facilitate direct engagement of the mounting feature with a surface of the machinery, the mounting feature and first and second offset distances preventing direct application of engagement forces to the front and rear surfaces of the monitor

A method is disclosed for monitoring the condition of machinery. The method comprises: obtaining first and second machinery condition signals from first and second sensors, the first and second machinery condition signals representative of first and second operating conditions of the machinery; generating a first alarm signal if at least one of the machinery condition signal indicates an operating condition in excess of a first predetermined and user adjustable criteria; generating a second alarm signal if the at least one machinery condition signal indicates an operating condition in excess of a second predetermined and user adjustable criteria; and displaying a first visual indication when the first alarm signal is generated, and displaying a second visual indication when the second alarm signal is generated, the first visual indication being different from the second visual indication. The first machinery condition signal may be obtained at a first elapsed time after obtaining an immediately preceding first machinery condition signal, and wherein the second machinery condition signal is obtained at a second elapsed time after obtaining an immediately preceding second machinery condition signal, wherein the first and second elapsed times are different.

### BRIEF DESCRIPTION OF THE DRAWINGS

By way of example, a specific embodiment of the disclosed device will now be described, with reference to the accompanying drawings:

FIG. 1 is a perspective view of the disclosed monitoring system;

FIG. 2 is a front view of the monitoring system of FIG. 1;

FIG. 3 is a cross-section view of the monitoring system of FIG. 1, taken along line 3-3 of FIG. 2;

FIG. 4 is an exemplary schematic of the monitoring system of FIG. 1; and

FIG. 5 is a flowchart illustrating an exemplary method for using the monitoring system of FIG. 1.

### DETAILED DESCRIPTION

The disclosed monitoring system facilitates monitoring of a wide variety of system machinery in a compact, easy to use device. In an exemplary non-limiting embodiment, the disclosed system can be used to monitor temperature and vibration levels of machinery such as pumps. The system provides continuous feedback on machinery performance, and can be used to reduce maintenance expenses and minimizing downtime.

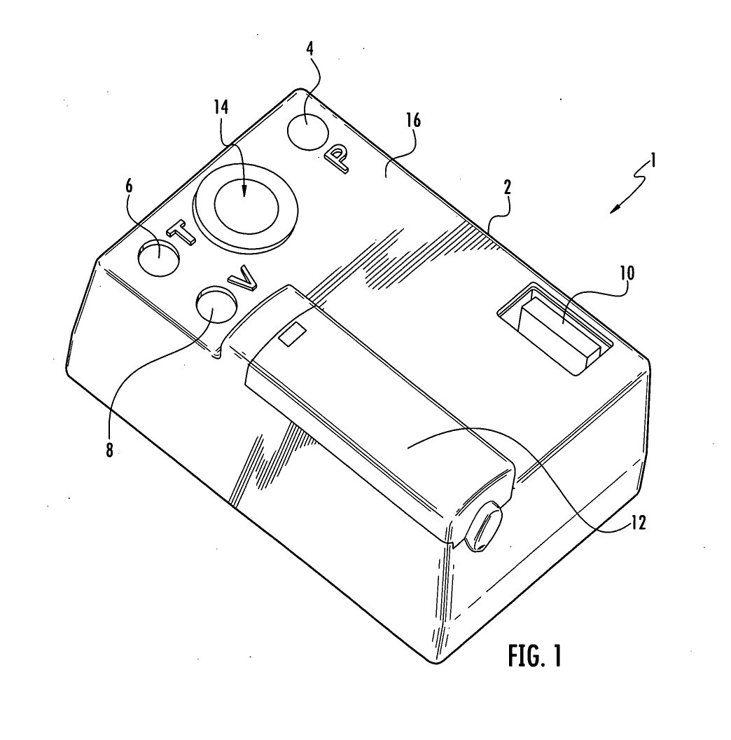

Referring now to FIGS. 1-3, the monitor 1 includes a casing 2 having a plurality of visual indicators 4, 6, 8, for providing monitor status information and machinery condition information to a user. In one embodiment, the visual indicators 4, 6, 8 are light emitting diodes (LEDs). The casing may include a port 10 to enable a user to control one or more functions or settings of the monitor 1. A battery door 12 is provided on a front surface of the monitor 1 to accommodate a replaceable battery power source. The monitor 1 can also include a mounting feature 14 to enable the device to be attached to a surface of the machinery to be monitored. In the illustrated embodiment this mounting feature 14 is a metal cylinder configured to receive a bolt or other appropriate fastener.

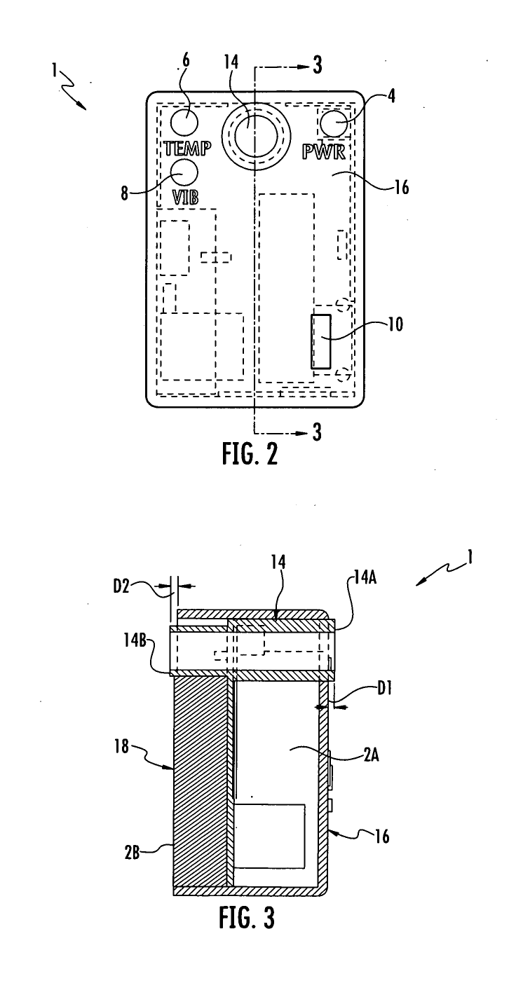

As noted, the visual indicators 4, 6 and 8 may provided readily viewable status or condition information relating to the monitor 1 and/or the machinery being monitored. In the FIG. 2 embodiment, first visual indicator 4 bears the label “PWR,” identifying it as representative of a power condition of the monitor. Second visual indicator 6 bears the label “TEMP,” identifying it as representative of a temperature condition of the machinery being monitored, while third visual indicator 8 bears the label “VIB” identifying it as representative of a vibration condition of the monitored equipment. As will be described in greater detail later, various colors and flashes from these visual indicators may relay information regarding a condition of the monitor 1 and/or the machinery being monitored.

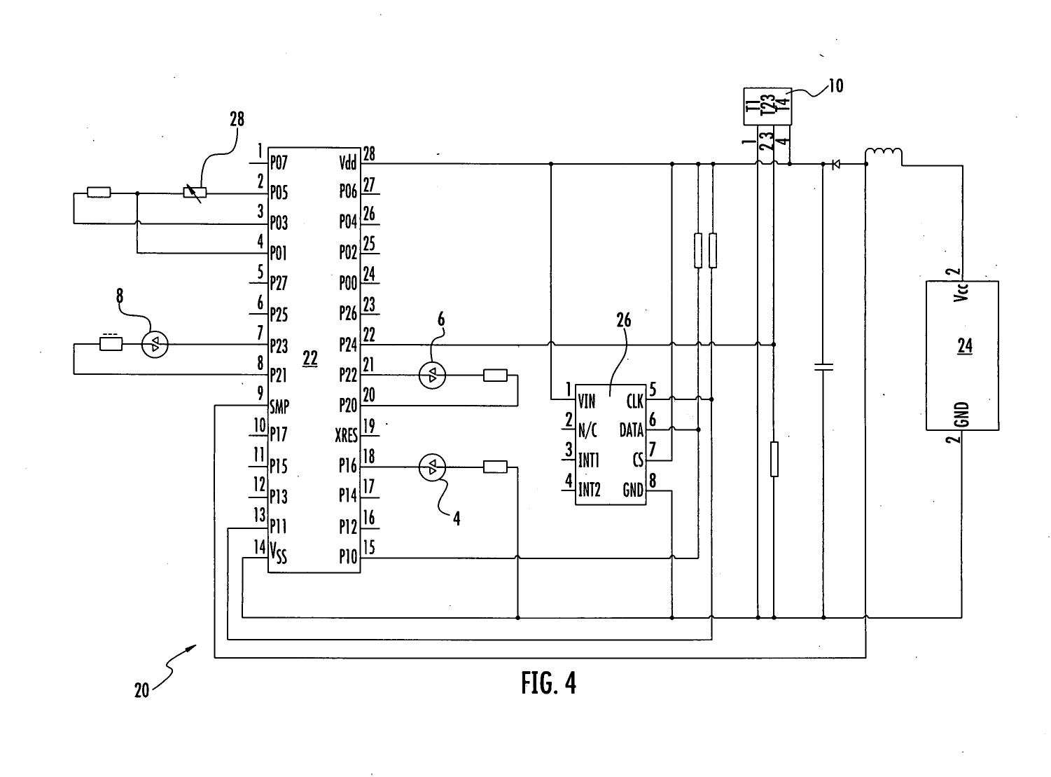

FIG. 3 is a cross-section view of the monitor 1 showing the positioning of the mounting feature 14 with respect to the casing 2. As illustrated, the monitor 1 has a front surface 16 and a back surface 18 with mounting feature 14 disposed therebetween. The mounting feature 14 has a first end 14A that extends beyond the front surface 16 by a first distance “D1” and a second end 14B that extends beyond the back surface 18 by a second distance “D2.” In one embodiment, D1 is about 1/32-inch, while and D2 is about 1/16-inch.

As previously noted, the mounting feature 14 is configured to receive a bolt or other fastener to enable the monitor 1 to be attached to the machinery that will be monitored. In one embodiment, a threaded end of the bolt or other fastener will be received in a tapped hole in the monitored machinery. Thus, as installed, the second end 14B of the mounting feature 14 will contact an external surface of the machinery, while a head of the bolt/fastener will contact the first end 14A of the mounting feature 14. It will be appreciated that by extending the mounting feature 14 beyond the front and back surfaces 16, 18 of the monitor 1, the compression forces caused by bolt/fastener installation torquing are borne entirely by the mounting feature 14, and are isolated from the casing 2. Such isolation prevents the casing and internal components from being damaged during installation of the monitor 1.

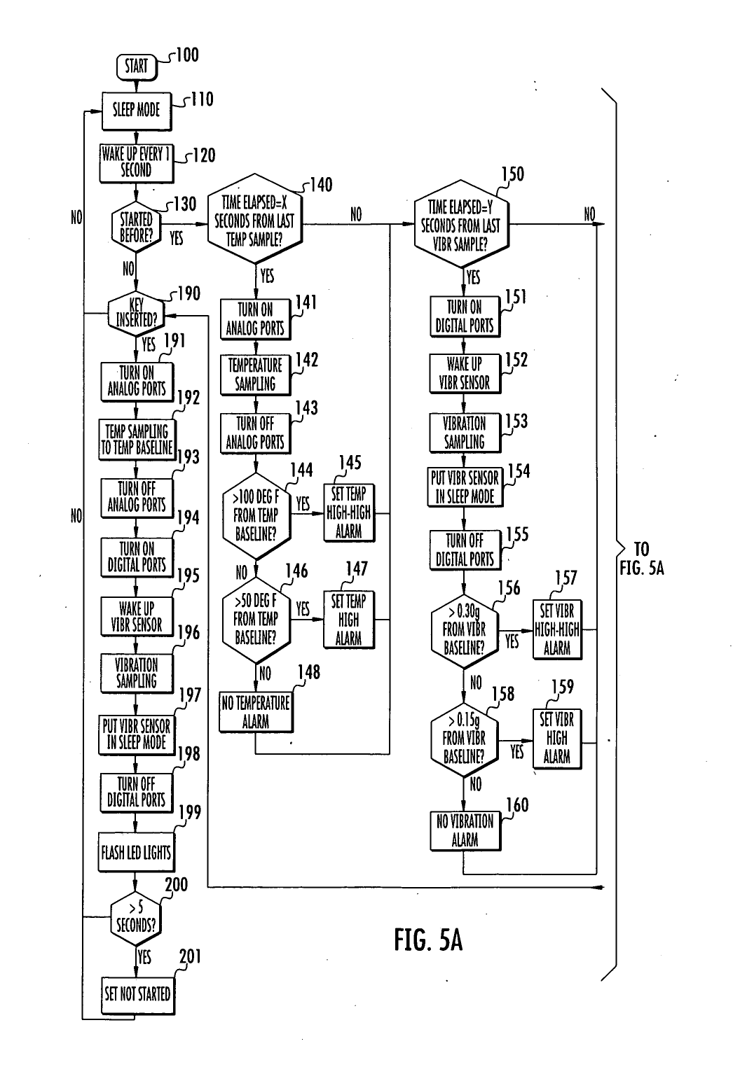

In addition, the illustrated mounting feature arrangement ensures tight engagement between the monitored machinery and the second end 14B of the mounting feature 14, thus facilitating heat transfer from the machinery to the temperature sensor 24 (FIG. 4). In one embodiment, the temperature sensor 24 comprises a thermistor attached directly to the mounting feature 14. The mounting feature 14 is formed of a metal having good heat transfer characteristics (e.g., steel), and thus the disclosed arrangement assures that that the machinery temperature may be accurately and quickly sensed by the monitor's temperature sensor.

FIG. 3 shows the casing 2 split into a pair of compartments 2A, 2B which house the internal components and circuitry of the monitor 1. In one embodiment, the first compartment 2A houses the battery and external port 10, while the second compartment 2B houses the remaining electrical components and circuitry. As illustrated, the second compartment 2B comprises a recess within which the electrical components and circuitry are disposed and encased in potting compound.

Referring now to FIG. 4, an exemplary schematic of the operational and control circuitry 20 of the monitor 1 is shown. The control circuitry 20 includes a processor 22 operatively coupled to a power source 24, a vibration sensor 26, a temperature sensor 28, visual indicators 4, 6 and 8 and external port 10.

The power source 24 may be a replaceable lithium ion battery, such as a 3.6 V, ½ AA battery. The vibration sensor 26 may be a 3-axis accelerometer having a range of about +/−4 g, and the temperature sensor 28 may be a thermistor having a range of −40° F. to about 185° F. The visual indicators 4, 6 and 8 may be single or multi-color LED's, while the external port 10 may be a USB port.

As will be understood, the processor 22 may periodically sense signals from the vibration and temperature sensors 26, 28 and the power source 24 and may command operation of one or more of the visual indicators 4, 6 and 8 accordingly. For example, the processor 22 may periodically sense signals from the vibration and temperature sensors 26, 28 and compare the signals to one or more baseline levels. If the sensed signals represent a measured value exceeding a first level, the associated visual indicator may be commanded to flash a first color (e.g., yellow), while if the sensed signals represent a measured value exceeding a second level, the associated visual indicator may be commanded to flash a second color (e.g., red). In such applications, the visual indicators 6 and 8 may comprise bi-color LEDs.

In one embodiment, the first level may represent a measured temperature of at least 50 degrees F. above a baseline temperature value and a measured vibration of at least 0.15 g above a baseline vibration value. The second level may represent a measured temperature of at least 100 degrees F. above the baseline temperature value and a measured vibration of at least 0.30 g above the baseline vibration value. Although two signaling levels have been disclosed, it will be appreciated that more than two can be provided. In addition, visual indicia other than color can be used to indicate machinery condition (e.g., flashing indicators could be used).

Once the first or second level has been reached, the associated visual indicator 6, 8 may remain flashing until reset by the user. In one embodiment, when activated, the visual indicators flash once every 5 seconds. Whenever at least one of the first or second levels have been reached, the visual indicator 4 representative of a power condition of the monitor 1 will stop blinking until the monitor 1 is reset, or the monitor is turned off and waken up again.

As will be appreciated, providing multiple machinery condition indicator levels facilitates greater flexibility in planning repair or replacement operations as compared to systems that provide a single indication of condition (e.g., good/trouble).

A user may control various functions of the monitor 1 via the external port 10. For example, the user may turn on/turn off the monitor or may reset the baseline levels of temperature and vibration. In one embodiment, the external port 10 interacts with an external key (not shown) which, when plugged into the external port 10, shorts a pair of pins on the processor 22. The processor 22 detects the short and recognizes it as an indication that the key is plugged in (conversely, if the circuit is open, the processor 22 knows no key is present and takes no action). In response to the presence of the external key in the port 10, the processor 22 commands one or more associated function (e.g., power on/off, baseline reset). As will be described in greater detail later, the processor 22 may distinguish between power on/off and a baseline reset functions by the amount of time the external key is engaged with the external port 10.

As noted, the external key/port 10 may function to activate/deactivate the monitor 1 in order to conserve battery life during periods in which the monitor 1 is not being used, for example, during shipping, or during repair of the associated machinery. As previously noted, a visual indicator 4 may identify the status of the power source 24. Typically, when the monitor 1 is operating and the power source 24 is above a certain minimum power level, the visual indicator 4 will periodically flash. In one embodiment, the visual indicator is a green LED that flashes once every 5 seconds to indicate the monitor 1 is operating and that the power level is satisfactory. If one or both of the temperature and vibration baseline levels has been exceeded, the LED may stop flashing.

If the visual indicator 4 is not blinking, it can mean that the power source 24 is at too low a level to support operation of the monitor 1, or that the monitor 1 has been deactivated (i.e., it has been placed into “deep sleep mode.”) “Deep sleep mode” may be used to conserve power during shipping, storage or maintenance. When in “deep sleep mode,” some or all of the functions of the monitor 1 may be shut down. In one embodiment, the monitor 1 is automatically placed into deep sleep mode whenever the power source 24 is replaced.

To “wake up” a monitor 1 that is in “deep sleep mode,” the external key can be inserted into the external port 10 and left in place for a predetermined time (e.g., five seconds). If the power source 24 is at too low a level to support operation of the monitor 1, then the visual indicator 4 will not light. Otherwise, the processor 22 will sense the short caused by insertion of the key and will reactivate the monitor 1.

The external key may also be used to reset baseline values for temperature and measurement, such as after an alarm condition has been indicated. In one embodiment, baseline reset is accomplished by plugging the key into the external port 10, and unplugging it again before the expiration of a predetermined time interval (e.g., 5 seconds). Upon unplugging, the processor 22 will store baselines for both temperature and vibration, and will automatically switch to normal operating mode.

It will be appreciated that the baselines can be reset at any time (i.e., not just under post-alarm conditions). When reset, both temperature baseline and vibration baselines will be reset to current conditions at the same time. Thus, when resetting the baselines, it may be important to ensure that the current system conditions are stable, and are indicative of healthy or acceptable conditions of the system.

If the key stays plugged into the external port 10 for greater than the predetermined time interval (e.g., 5 seconds), the monitor 1 will be placed into deep sleep mode. To wake up the monitor 1, the external key may be plugged back into the external port 10, and then unplugged again before expiration of the predetermined time interval. The device will wake up, acquire baselines, and go into normal operating mode.

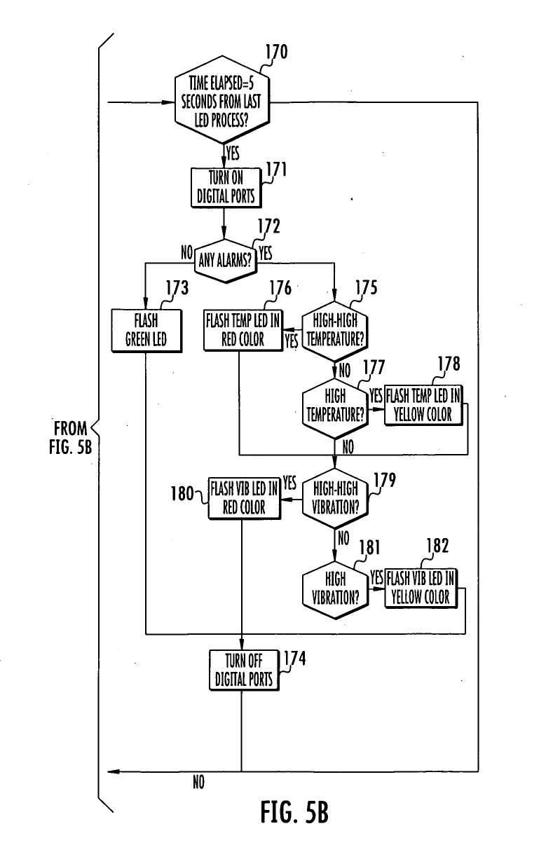

Referring now to FIG. 5, a method of operating the monitor of FIGS. 1-4 will be described. The method begins at step 100. At step 110, the monitor 1 is in “sleep mode.” At step 120, the monitor wakes up every 1 second. (It will be appreciated that this “sleep mode” in step 110 is different from the previously described “deep sleep mode.” That is, “sleep mode” is a system phase in which the system components are turned off in between sensor samplings. “Deep sleep mode” is a system phase in which the monitor is turned off completely.)

A decision is made at step 130 about whether the monitor 1 has been previously started. If the answer is no, then at step 190 a baseline reset algorithm is begun. If, however, the answer is yes, then at step 140 sampling algorithm is begun.

Specifically, at step 140 a decision is made about whether elapsed time is equal to a first prime number of seconds (e.g., 123 seconds) from the immediately previous temperature sampling operation. If the answer is no, then the process proceed to the vibration sampling phase at step 150. If, however, the answer is yes, then at step 141 the processor analog ports are turned on, at step 142 a temperature sample is taken, and at step 143 the analog ports are turned off. It will be appreciated that in some embodiments more than a single temperature sample may be taken at this step. For example, a plurality of temperature samples may be obtained and their average determined. In one embodiment, five samples are obtained and an average value is computed and used as the sample temperature “value.” At step 144, a decision is made about whether the sampled temperature is greater than 100° F. above the baseline temperature. If the answer is yes, then at step 145 a “high-high” temperature alarm is set. If the answer is no, then at step 146 a decision is made about whether the sampled temperature is greater than 50° F. above the baseline temperature. If the answer is yes, then at step 147 a “high” temperature alarm is set. If the answer is no, then at step 148 no temperature alarm is set. If either alarm is set, or if no alarm is set, then the process proceeds to step 150.

At step 150, a decision is made about whether an elapsed time is equal to a second prime number of seconds (e.g., 61 seconds) from the immediately previous vibration sampling operation. In one embodiment, the second prime number is different from the first prime number. If the answer is no, then the process proceeds to the LED flash control phase at step 170. If, however, the answer is yes, then at step 151 the processor digital ports are turned on, at step 152 the vibration sensor is woken up, at step 153 a vibration sample is taken, at step 154 the vibration sensor is put back into sleep mode, and at step 155 the processor's digital ports are turned off. As with the temperature sensing operation, more than a single vibration sample may be taken at this step. For example, a plurality of vibration samples may be obtained and their average determined. In one embodiment, five samples are obtained and an average value is computed and used as the sample vibration “value.” At step 156, a decision is made about whether the sampled vibration is greater than 0.30 g above the baseline vibration. If the answer is yes, then at step 157 a “high-high” vibration alarm is set. If the answer is no, then at step 158 a decision is made about whether the sampled vibration is greater than 0.15 g above the baseline vibration. If the answer is yes, then at step 159 a “high” vibration alarm is set. If the answer is no, then at step 160 no temperature alarm is set. If either alarm is set, or if no alarm is set, then the process proceeds to step 170.

At step 170, a decision is made about whether an elapsed time is equal to a predetermined amount of time (e.g., 5 seconds) from the immediately previous LED flash control process. If the answer is no, then the process proceeds to step 180. If, however, the answer is yes, then the process proceeds to step 171 and the processor's digital ports are turned on. At step 172 a determination is made whether any alarms have been signaled. If the answer is no, then at step 173 the first visual indicator 4 is instructed to flash green. At step 174, the processor's digital ports are turned off, and the process returns to step 190. If, at step 172, the answer is yes, then at step 175 a determination is made about whether the alarm is a “high-high” temperature alarm. If the answer is yes, then at step 176, the second visual indicator 6 is instructed to flash red. If the answer is no, then at step 177, a determination is made about whether the alarm is a “high” temperature alarm. If the answer is yes, then at step 178, the second visual indicator 6 is instructed to flash yellow.

The process then proceeds to step 179, where a determination is made about whether the alarm is a “high-high” vibration alarm. If the answer is yes, then at step 180, the third visual indicator 8 is instructed to flash red. If the answer is no, then at step 181, a determination is made about whether the alarm is a “high” vibration alarm. If the answer is yes, then at step 182, the third visual indicator 8 is instructed to flash yellow. The process then proceeds to step 174, where the processor's digital ports are turned off, and the process proceeds to step 190.

At step 190, a temperature and vibration baseline setting algorithm is begun. Specifically, at step 190 a determination is made as to whether an external key has been inserted in port 10. If the answer is no, then the process returns to step 110 and the monitor is temporarily placed into “sleep mode.” If, however, the answer is yes, then the process proceeds to step 191 where the processor's analog ports are turned on, at step 192 a temperature sample is taken and set as the baseline temperature value, at step 193 the processor's analog ports are turned off, at step 194 the processor's digital ports are turned on, at step 195 the vibration sensor is woken up, at step 196 a vibration sample is taken and set as the baseline vibration value, at step 197 the vibration sensor is placed back into sleep mode, at step 198 the digital ports are turned off, and at step 199 the visual indicators are flashed.

At step 200, a determination is made as to whether an elapsed time is greater than 5 seconds. If the answer is no, then the process returns to step 110, where the monitor 1 is temporarily placed back into sleep mode. If, however, the answer is yes, then the process turns to step 201, where a flag (either yes/no, good/bad) is set identifying whether the device has been started (i.e., put into operation mode) or not (i.e., is in deep sleep mode). If the key has been plugged more than 5 second, then this flag is set. At the beginning of the next iteration, at block 130, this flag will be checked. If the flag has not been set, then the device is determined to have previously been put into operation mode (i.e., the key was plugged in, and the duration of plug-in was less than 5 seconds). If, however, the flag is set, then device is determined to be in deep sleep mode (i.e., not started).

As described, the monitor 1 may provide a variety of information relating to the machinery to which it is attached. It will be appreciated that although the monitor 1 has been described as providing monitored temperature and vibration information to a user, such functionality is merely exemplary, and other information can also be provided.

As described, the disclosed monitor 1 provides a variety of advantages as compared to prior designs. For example, in order to even up the current draw of the monitor over time, and to reduce the peak current consumption for any given time, tasks like LED lighting, temperature sampling and vibration sampling may be separated. In particular, the periods for LED lighting, temperature sampling and vibration sampling may be set to a prime/odd number of seconds to make sure that only one task is being performed at a given time. As will be appreciated, this reduces the current peak when performing these tasks, evens up the current draw over time, and therefore, increases battery life.

In addition, the monitor 1 uses a Switch Mode Pump (SMP) mechanism of the processor 22 in both software and hardware levels. The processor 22 requires a voltage level greater than 3.0 VDC, and the SMP allows the device to operate even when the power supply voltage level drops below 3.0 VDC (down to 1.5V).

Further, the monitor 1 uses a method, combining a low-cost thermistor and a reference resistor, to measure temperature. The method allows the cancellation of the temperature variations of the resistor and thermistor to achieve high accuracy and low cost.

The monitor 1 places the processor and associated sensors in deep sleep mode, and periodically wakes them up for measurement. The monitor 1 employs an external key to wake up from deep sleep mode, to measure baselines, and to put itself into deep sleep mode.

Some embodiments of the disclosed device may be implemented, for example, using a storage medium, a computer-readable medium or an article of manufacture which may store an instruction or a set of instructions that, if executed by a machine, may cause the machine to perform a method and/or operations in accordance with embodiments of the disclosure. Such a machine may include, for example, any suitable processing platform, computing platform, computing device, processing device, computing system, processing system, computer, processor, or the like, and may be implemented using any suitable combination of hardware and/or software. The computer-readable medium or article may include, for example, any suitable type of memory unit, memory device, memory article, memory medium, storage device, storage article, storage medium and/or storage unit, for example, memory (including non-transitory memory), removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Based on the foregoing information, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to its preferred embodiment, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements; the present invention being limited only by the claims appended hereto and the equivalents thereof. Although specific terms are employed herein, they are used in a generic and descriptive sense only and not for the purpose of limitation.

What is claimed is:

1. A machinery condition monitor, comprising:
a plurality of sensors;
a controller for receiving input from the plurality of sensors and determining at least one operating characteristic of the machinery from said input; and
a mounting feature for attaching the plurality of condition sensors and the controller to the machinery;
wherein the mounting feature is offset by a first offset distance beyond a front surface of the machinery condition monitor and is offset by a second offset distance beyond a rear surface of the machinery condition monitor;
wherein the first offset distance facilitates engagement between the mounting feature and a fastener used to couple the monitor to the machinery, and the second offset distance facilitates direct engagement of the mounting feature with a surface of the machinery, the mounting feature and the first and second offset distances preventing direct application of engagement forces to the front and rear surfaces of the machinery condition monitor.

2. The machinery condition monitor of claim 1, wherein the plurality of sensors include a vibration sensor and a temperature sensor.

3. The machinery condition monitor of claim 1, wherein the mounting feature comprises a cylinder having first and second ends, the first end for engaging the surface of the machinery, the second end for engaging a head portion of the fastener for coupling the machinery condition monitor to the machinery.

4. The machinery condition monitor of claim 3, wherein at least one of the sensors is a temperature sensor coupled to the cylinder, and wherein the cylinder conducts heat directly from the machinery to the temperature sensor.

5. The machinery condition monitor of claim 4, wherein the temperature sensor is a thermistor attached directly to the cylinder.

6. The machinery condition monitor of claim 1, further comprising first and second warning indicators, the first warning indicator representing at least one of a measured temperature exceeding a first predetermined temperature level and a measured vibration exceeding a first predetermined vibration level, the second warning indicator representing a least one of a measured temperature exceeding a second predetermined temperature level and a measured vibration exceeding a second predetermined vibration level.

7. The machinery condition monitor of claim 6, wherein the first predetermined temperature level is at least 50 degrees F. above a baseline temperature value, the first predetermined vibration level is at least 0.15 g above a baseline vibration value, the second predetermined temperature level is at least 100 degrees F. above the baseline temperature value and the second predetermined vibration level is at least 0.30 g above the baseline vibration value.

8. The machinery condition monitor of claim 1, further comprising a port engageable by an external key, wherein when the external key is engaged with the port the controller senses the key and commands at least one of a power on operation, a power off operation, and a baseline reset operation.

9. The machinery condition monitor of claim 8, wherein the controller commands the power on, the power off, or the baseline reset operation based on a time period during which the external key is engaged with the port.

10. The machinery condition monitor of claim 1, further comprising a port engageable by an external key, wherein the controller is configured to reset a baseline temperature value and a baseline vibration value when the external key is engaged with the port for a period of time that is less than a predetermined time interval, wherein when the external key disengages from the port the controller stores a new baseline temperature value and a new baseline vibration value, the new baseline temperature value and new baseline vibration value comprising respective temperature and vibration values sensed by the plurality of sensors at the time the external key disengages from the port.

11. A method for monitoring the condition of machinery, comprising:
obtaining first and second machinery condition signals from first and second sensors, the first and second machinery condition signals representative of first and second operating conditions of the machinery;
generating a first alarm signal if at least one of the machinery condition signal indicates an operating condition in excess of a first predetermined criteria;
generating a second alarm signal if the at least one machinery condition signal indicates an operating condition in excess of a second predetermined criteria; and
displaying a first visual indication when the first alarm signal is generated, and displaying a second visual indication when the second alarm signal is generated, the first visual indication being different from the second visual indication;
wherein the first machinery condition signal is obtained at a first elapsed time after obtaining an immediately preceding first machinery condition signal, and wherein the second machinery condition signal is obtained at a second elapsed time after obtaining an immediately preceding second machinery condition signal, wherein the first and second elapsed times are different.

12. The method of claim 11, wherein the first predetermined criteria represents a temperature that is a first predetermined amount above a baseline temperature value, and the second predetermined value represents a temperature that is a second predetermined amount above the baseline temperature value.

13. The method of claim 11, wherein the first predetermined criteria represents a vibration level that is a first predetermined amount above a baseline vibration value, and the second predetermined value represents a vibration level that is a second predetermined amount above the baseline vibration value.

14. The method of claim 11, wherein the first visual indication is a red light and the second visual indication is a yellow light.

15. The method of claim 11, wherein the first machinery condition signal is representative of a temperature of the machinery, the first predetermined value is a first temperature, and the second predetermined value is a second temperature that is lower than the first temperature.

16. The method of claim 11, wherein receiving first and second machinery condition signals from a sensor comprises receiving a plurality of condition signals from the sensor and averaging the plurality of condition signals to obtain a single value.

17. The method of claim 16, wherein the plurality of condition signals comprise a plurality of signals representative of a temperature of the machinery.

18. The method of claim 16, wherein the plurality of condition signals comprise a plurality of signals representative of a vibration level of the machinery.

19. The method of claim 17, wherein the first machinery condition signal is representative of an operating temperature of the machinery, and the second machinery condition signal is representative of a vibration level of the machinery, the method comprising:
generating a first alarm signal if the first machinery condition signal indicates an operating temperature exceeding a first predetermined temperature value, or the second machinery condition signal indicates a vibration level exceeding a first predetermined vibration value;
generating a second alarm signal if the first machinery condition signal indicates an operating temperature exceeding a second predetermined temperature value, or the second machinery condition signal indicates a vibration level exceeding a second predetermined vibration value.

20. The method of claim 19, further comprising, prior to the step of receiving a first condition signal, the steps of:
determining a first elapsed time, the first elapsed time being a time that has elapsed since a previous temperature sample, and
receiving the first condition signal only if the first elapsed time is equal to a first prime number of seconds

21. The method of claim 20, further comprising, prior to the step of receiving a second condition signal, the steps of:
determining a second elapsed time, the second elapsed time being a time that has elapsed since a previous vibration sample, and
receiving the second condition signal only if the second elapsed time is equal to a second prime number of seconds.

22. The method of claim 21, wherein the second prime number is different from the first prime number.
